(19) United States
(12) Patent Application Publication
(10) Pub. No.: US 2008/0294333 A1
(43) Pub. Date: Nov. 27, 2008

(54) Method For Operating A Navigation System

(76) Inventor: Christof Engel, Wurzburg (DE)

Correspondence Address: QUARLES & BRADY LLP, 411 E. WISCONSIN AVENUE, SUITE 2040, MILWAUKEE, WI, 53202-4497, US

(21) Appl. No.: 12/105,830

(22) Filed: Apr. 18, 2008

(30) Foreign Application Priority Data
May 21, 2007 (DE) 10 2007 023 804.7

(51) Int. Cl. G01C 21/00

(52) U.S. Cl. 701/202

(57) ABSTRACT

Method for operating a navigation system for calculating a travel route, whereby a starting point and a destination point are entered via an input device and whereby a trip calculator calculates a travel route leading from the starting point to the destination point by taking into account road network data, whereby a guideline time is additionally input via an input device whereby the trip calculator calculates a travel route which leads from the starting point to the destination point in a predicted travel time corresponding essentially to the guideline time by taking into account road network data.

### CROSS-REFERENCE TO RELATED APPLICATION

This application claims the priority benefit of German Patent Application No. 10 2007 023 804.7 filed on May 21, 2007, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention relates to a method for operating a navigation system in which a starting point and a destination point are entered via an input device and whereby a trip calculator calculates a travel route leading from the starting point.

### BACKGROUND OF THE INVENTION

There are navigation systems which are known as mobile navigation devices for motor vehicles, for example, into which the user can enter a starting point and a destination point. A trip calculator then calculates a travel route that guides the user from the starting point to the destination point, wherein the road network data stored in a database is taken into account. In calculating the travel route, either the fastest travel route or the shortest travel route between the starting point and the destination point is calculated.

EP 1 217 331 A1 describes a method in which estimated travel times are assigned to individual trip sections in the road network database. These estimated travel times can be modified dynamically by traffic messages. In trip planning, the estimated travel times are used to predict the total travel time and thus to calculate the fastest route for the user.

DE 198 23 123 C2 and EP 1 571 420 A2 describe methods in which a desired arrival time can be preselected. Based on this preselected arrival time, a warning is output to the user indicating the latest possible time to begin the trip in order to maintain the desired arrival time. Various boundary conditions such as the traffic situation are taken into account here.

One disadvantage of the known methods for operating navigation systems is that it is regularly assumed that the distance between the starting point and the destination point is to be traveled in the shortest possible time and/or along the shortest possible path. However, this approach is inadequate for certain activities, in particular leisure time activities. Especially in leisure time activities, the available time is an initial boundary condition, but it cannot be taken into account with the known navigation systems.

Based on this state of the art, the object of the present invention is to propose a novel method for operating a navigation system in which the time available to the user may be taken into account as an initial boundary condition.

This object is achieved in one embodiment by operating a navigation system for calculating a travel route, whereby a starting point and a destination point are entered via an input device and whereby a trip calculator calculates a travel route leading from the starting point to the destination point by taking into account road network data. In a preferred embodiment, a guideline time is additionally entered via the input device, whereby the trip calculator calculates a travel route by taking into account the road network data, the travel route leading from the starting point to the destination point in a predicted travel time that corresponds essentially to the guideline time.

The inventive method is based on the fundamental idea that the starting point, the destination point and the available time (guideline time) are preselected for the navigation system as the initial boundary conditions. In other words, this means that the user specifies for the system where he wants to start, where he wants to arrive and approximately how much time is available for the trip from the starting point to the destination point. Based on these initial boundary conditions, the navigation system then calculates a travel route with a travel time that is predicted for locomotion from the starting point to the destination point. The route is varied through appropriate calculation methods until the predicted travel time matches the preselected guideline time.

As a result, the user thus has the option of optimally utilizing the guideline time to travel the given distance. This is a great advantage in particular for leisure activities such as jogging, hiking, bicycling, riding a motorcycle or visiting towns.

In calculating the travel route, taking into account the starting point, the destination point and the desired guideline time, this often results in solutions that are not unique. Instead, in most cases, the preselected routing task can be solved by a plurality of travel routes. Certain criteria may be stored in the navigation system to select a travel route from the various travel routes that solve the given task. For example, the choice may be made by taking into account particularly attractive tourist destinations or especially attractive stretches of road, e.g., for motorcyclists, stretches of roads with a large number of curves. As an alternative to the automatic selection of a travel route, it is also possible for a plurality of travel routes to be calculated to solve the routing task formulated, whereby then at least two of these travel routes are offered to the user as alternatives. The user then has the opportunity of selecting a travel route from the various travel routes made available and then actually traveling along this selected travel route from the starting point to the destination point. To do so, it is advantageous if the user can consider the routes offered as alternatives in the navigation system, e.g., on the map. Following this, the user can then decide which of the routes offered he wants to select.

To be able to process the routing task formulated, namely the calculation of a travel route leading from the starting point to the destination point within a preselected guideline time, a certain travel speed is necessary as a boundary condition for the simplest calculation variants. In other words, if the average predicted speed of travel is known, then the preselected routing calculation can be performed relatively easily. Prediction of the presumed speed of travel by the navigation system, in particular as a function of traffic jam reports and the available types of road (country road, highway), is known from the state of the art. However, for certain applications, it is particularly advantageous if the predicted speed of travel can be preselected by the user as an additional boundary condition. For example, in planning fitness runs or guided city tours by means of the navigation system, it is advantageous if the user can set his own speed of travel as a boundary condition.

As an alternative, it is also conceivable for the user to preselect his type of locomotion, e.g., as a pedestrian, a jogger, a bicyclist, a motorcyclist or an automobile driver. Depending on this preselected type of locomotion, the navigation system can automatically calculate the predicted speed of travel by taking into account certain criteria, e.g., known average speeds of pedestrians, bicycles, motorcycles or automobiles. It is especially advantageous if the road network database is also analyzed additionally because the speed of locomotion in the individual types of movement will also depend greatly on the available road sections.

### SUMMARY OF THE INVENTION

According to this invention, the navigation method is based on seeking a travel route for the completion of which the user requires a predicted travel time that essentially matches the guideline time preselected by the user. In most cases, however, it is impossible to calculate a travel route that can be traveled in exactly the guideline time. In other words, this means that in a comparison between predicted travel time and preselected guideline time, a tolerance value should preferably be taken into account. If this travel time predicted for a travel route is within the tolerance range around the guideline time, then the travel route is assumed to be the solution to the routing task. If the predicted travel time is outside of the tolerance range, then the travel route is not considered to be the solution to the routing task.

The tolerance range around the preselected guideline time can be fixedly preset to indicate the preselected guideline time in percent, for example. For example, it is conceivable for all travel routes to be assumed as a solution to the routing task if they have only a 3% deviation in the predicted travel time in comparison with the preselected guideline time. Depending on the preselected tolerance, the result is thus more or fewer solution routes accordingly. According to a preferred embodiment of the method, it is therefore proposed that the tolerance value shall be variable by the user to be able in this way to have an influence on the solution routes given as a solution.

With the navigation systems known from the state of the art, the main task is to guide the user from a starting point X to a destination point Y. Through the use of the inventive method, a novel possible use for navigation systems can be proposed, deviating significantly from the intended purpose of user guidance from starting point X to destination point Y. According to this variant of the method, the starting point and the destination point correspond to one another. In other words, the boundary condition of the routing task to be solved is the calculation of a round trip taking the user from the starting point X back to the starting point X within the preselected guideline time. Calculation of such round trips is of great importance for leisure time activities in particular, e.g., for hikes, fitness runs, city tours, motorcycle tours or automobile tours. The user then has an opportunity to preselect a starting point, e.g., his current location, and the time available as a guideline time. The navigation system then automatically calculates a round trip, which will take the user back to his starting point within the preselected guideline time.

To make the operation as simple and intuitive as possible for the user, the current location at the start of the calculation of the travel route is automatically taken as the starting point. In this variant of the method, for example, only input of the preselected guideline time would be necessary to calculate a round trip, in which case the navigation system would then automatically calculate the required travel route without any further information. Alternatively and/or in addition to this variant of the method for calculation of a round trip, input of intermediate destination points may also be provided according to another variant of the method. Second boundary conditions are thus preselected for the navigation system as intermediate destination points, which must be included in the travel route, for calculation of the travel route. Therefore, for example, the user would have an opportunity to preselect certain fixed intermediate destinations, e.g., tourist attractions, to ensure that the travel route calculated by the navigation system goes past this intermediate destination.

Input of the starting point, destination point and/or intermediate destination point may be designed to be especially simple if these are stored in the road network database. These may be addresses stored in the road network database, points of interest, towns or regions, e.g., nature conservation regions or mountain ranges. It may also be possible to just input a region, e.g., a nature conservation region (Rhön) or a mountain range (Allgäu, Spessart, Zillertal).

In calculating a trip in which a certain region is specified, it is advantageous that leaving this region is avoided and/or ruled out. A round trip may therefore be limited to the corresponding region in particular. If the region is entered as an intermediate destination, then the route will lead through this region.

The solution to the preselected routing task also depends on whether the preselected guideline time allows the preselected path between the starting point and the destination point to be traveled at all. In other words, if the guideline time is selected to be too short, then no travel route can solve the routing task as formulated. Calculation models for calculating the fastest travel time while following the fastest travel route between the starting point and the destination point are methods that are available anyway with most of the known navigation systems. To avoid routing tasks that cannot be solved due to the guideline times being selected as too short and/or to draw the user's attention to the fact that the guideline times specified are too short, it is therefore especially advantageous if the preselected guideline time is compared with the fastest predicted travel time. If the preselected guideline time is shorter than the fastest predicted travel time, then this means that the routing task cannot be solved. In this case, the user may be informed of the lack of agreement. As an alternative to this, it is also conceivable for the user to be instructed to enter a new longer guideline time to allow a solution to the routing task. In addition, it is conceivable for the navigation system to automatically accept the fastest predicted travel time as the new guideline time and to display the corresponding travel route. The time difference between the preselected guideline time and the fastest predicted travel time may also be given to show the user the qualitative and/or quantitative differentiation of the path that is theoretically the fastest.

There are known routing methods in which the actual travel progress is compared dynamically with the predicted travel progress. Such dynamic calculation methods are of particularly great advantage in combination with the inventive approach because as soon as a deviation between the actual travel progress and the predicted travel progress is detected, a new calculation of the travel route may be initiated, in which case then a modified travel route is calculated starting from the altered boundary conditions, the modified travel route again taking into account the guideline time. If the user has taken an unscheduled break, for example, and therefore has lost time, the navigation system is able to calculate dynamically a shortened travel route which ensures that the guideline time will be met despite the loss of time due to the break.

When using the inventive method for navigation of motor vehicles, traffic disruptions constitute an interference variable that cannot be predicted in advance. It is therefore especially advantageous in the dynamic recalculation to also take into account traffic information, in particular TMC traffic jam reports. For example, if the system recognizes that there is a significant traffic disruption on the planned travel route, there is the possibility of recalculating the travel route, in which case compliance with the guideline time is then taken into account as a boundary condition on the one hand, and the detour around the area of traffic disruptions is also taken into account on the other hand.

The inventive method is based on taking into account the time as an initial boundary condition. According to a preferred process variant, not only is the desired travel time preselected as a guideline time but the desired break times may also be entered via the input device and taken into account in calculation of the travel route. In planning a trip, the user thus has the simple opportunity to preselect certain break times, possibly even specifying the desired location of the break. The location of the break may thus be connected to a certain desired break time as an intermediate destination. The system then calculates a travel route that complies with the desired break time at the desired break intermediate destination.

As already explained, the routing task presented yields solutions that are not unique, but instead a plurality of alternative travel routes which solve the same initial boundary conditions, namely traveling the distance between the starting point and the destination point within the preselected guideline time, are conceivable. It is therefore especially appropriate if the different alternative routes can be evaluated to automatically select one travel route from the alternatives and propose it to the user. One method of evaluating the travel routes is for the road network database to contain evaluation data on the individual route segments, which may be road segments or individual destinations. For example, it is conceivable for the individual route segments to be weighted from the standpoint of their sightseeing relevance. Taking into account this evaluation data, the alternative travel routes can be evaluated automatically from the corresponding standpoint, e.g., the standpoint of sightseeing relevance, in which case the travel route having the highest evaluation is then offered.

In certain applications, e.g., in planning motorcycle tours starting from a certain vacation site, it may happen that the user wishes to specify different travel routes having the same starting point and/or destination point. In this case, there is the risk that the navigation system might always give the same travel route based on its evaluations. To prevent this, it is conceivable for the evaluation of route segments that have already been traveled to be lowered. The evaluation of route segments that have not yet been traveled is therefore increased relatively, which also increases the probability of taking the next travel route proposed by the navigation system into account.

If the evaluation of route segments that have already been traveled is lowered, it is especially appropriate for the reduction to be as a function of time. In other words, if a relatively long time has already elapsed between the last time the route segment of the next planned route was traveled, then to travel it again is less critical than if there has only been a very short period of time since the last time the route was traveled.

According to another variant of the method, the user has an opportunity to block individual route segments via the input device and thereby exclude them from the calculation of the travel route. In this way, the user has an opportunity to rule out from the beginning route segments that he does not want to use in any case, e.g., because of increased risks or because of other boundary conditions, e.g. toll roads. For the method according to this invention, this yields a number of new possible applications, in particular for city tours, museum tours, for planning runs, hikes, bicycle tours, motorcycle tours or automobile tour.

The calculation of the travel route with the inventive method may be performed either on a mobile navigation device with a position receiver, in particular a GPS receiver, not only to calculate the travel route for the users but also to guide them along the travel route through appropriate navigation instructions. As an alternative to this, however, the inventive method may also be used strictly as a planning instrument and may be executed on a personal computer or an Internet portal, for example.

1. A method for operating a navigation system for calculating a travel route, whereby a starting point and a destination point are entered via an input device and whereby a trip calculator calculates a travel route leading from the starting point to the destination point by taking into account road network data, said method comprising:
entering a guideline time via the input device, whereby the trip calculator calculates a travel route by taking into account the road network data, the travel route leading from the starting point to the destination point in a predicted travel time that corresponds essentially to the guideline time.

2. The method according to claim 1, in which multiple travel routes are calculated, leading from the starting point to the destination point in a predicted travel time that corresponds essentially to the guideline time, whereby at least two of the travel routes are offered as alternatives.

3. The method according to claim 1, in which the travel route is calculated by taking into account a predicted speed of travel.

4. The method according to claim 3, in which the predicted speed of travel can be preselected.

5. The method according to claim 3, in which a type of locomotion can be preselected, whereby the predicted speed of travel is derived automatically from the type of locomotion, in particular by taking into account the road network database.

6. The method according to any claim 1, in which a tolerance value is taken into account in a comparison between the guideline time and the predicted travel time.

7. The method according to claim 6, in which the tolerance value is variable.

8. The method according to claim 1, in which the starting point and the destination point correspond to one another and the trip calculator calculates a round trip leading from the starting point back to the starting point.

9. The method according to claim 1, in which the current location is accepted automatically as the starting point at the start of calculation of the travel route.

10. The method according to claim 1, in which additionally at least one intermediate destination point is entered via the input device, whereby the trip calculator calculates a travel route leading from the starting point to the destination point by taking into account the road network data, said travel route going via an intermediate destination point in a predicted travel time which corresponds essentially to the guideline time.

11. The method according to claim 1, in which the starting point and/or destination point and/or intermediate destination point is/are an address stored in the road network database and/or a point of interest stored in the road network database and/or a town stored in the road network database and/or a region stored in the road network database.

12. The method according to claim 11, in which the route does not depart from the region preselected by the user in calculation of the travel route, in particular in calculation of a round trip leading from the starting point back to the starting point.

13. The method according to claim 1, in which the guideline time is compared with the fastest predicted travel time obtained by maintaining the fastest travel route between the starting point and the destination point, whereby, if the guideline time is shorter than the fastest predicted travel time,
a) an indication of this lack of correspondence is given and/or
b) the user is instructed to enter a new longer guideline time and/or
c) the fastest predicted travel time is automatically accepted as the new guideline time and/or
d) the time difference between the guideline time and the fastest predicted travel time is given.

14. The method according to claim 1, in which the actual travel progress is compared dynamically with the predicted travel progress, whereby the travel route is recalculated dynamically to maintain the guideline time if there are deviations between the actual travel progress and the predicted travel progress.

15. The method according to claim 14, in which with significant changes in the predicted travel progress, the travel route is recalculated dynamically to maintain the guideline time by shortening the travel route.

16. The method according to claim 14, in which traffic information, in particular TMC traffic jam reports, ire received and taken into account dynamically in calculation of the predicted travel progress.

17. The method according to claim 16, in which when there are significant changes in the predicted travel progress due to traffic disruptions, the travel route is recalculated dynamically to maintain the guideline time by bypassing the areas with traffic disruptions.

18. The method according to claim 1, in which desired break times are entered via the input device and are taken into account in calculating the travel route.

19. The method according to claim 18, in which a break destination point is assigned to a break time, whereby the break destination point is entered via the input device or is generated automatically by taking into account the road network data.

20. The method according to claim 1, in whichthe road network database contains evaluation data for tourist evaluation of the stored route segments in particular, whereby route segments with a high evaluation are preferred over route segments having a low evaluation in calculation of the travel route.

21. The method according to claim 20, in which the evaluation of route segments that have already been traveled is lowered.

22. The method according to claim 21, in which the lowering of the evaluation of route segments that have already been traveled is varied as a function of the time since the last time the route segment was traveled.

23. The method according to claim 1, in which a route segment is blocked via the input device and thereby ruled out in calculation of the travel route.

24. The method according to claim 1, in which a city tour or a museum tour or a jogging route or a hiking route or a bicycle tour or a motorcycle tour or an automobile tour is calculated with this method.

25. The method according to claim 1, in which the calculation of the travel route is performed on a mobile navigation device or on a personal computer or on an Internet portal.
